(19) United States
(12) Patent Application Publication
(10) Pub. No.: US 2003/0070273 A1
(43) Pub. Date: Apr. 17, 2003

(54) Close-on-disconnect IV line connector pair

(76) Inventor: Richard Kust, Aliso Viejo, CA (US)

Correspondence Address: Howard J. Klein, Klein, O'Neill & Singh, 2 Park Plaza, Suite 510, Irvine, CA, 92614, US

(21) Appl. No.: 09/977,129

(22) Filed: Oct. 12, 2001

(51) Int. Cl. B23P 11/00

(52) U.S. Cl. 29/426.1; 29/428

(57) ABSTRACT

A close-on-disconnect IV line connector pair includes a first connector element that includes normally-closed valve, and a second connector element, wherein the coupling of the first and second connector elements automatically opens the valve, and wherein the disconnecting of the first and second connector elements allows the valve to return to its normally-closed position. Specifically, the first connector element has an inlet end, an outlet end, and an internal valve orifice. The inlet end is configured for attachment to an upstream conduit, while the outlet end is configured for coupling with the second connector element. The valve includes a pair of flexible valve elements that normally close against each other, so that the valve has a normally closed position that prevents fluid flow through the valve orifice. The second connector element has an outlet end configured for attachment to a downstream conduit and an inlet end configured for coupling with the first connector element. The inlet end has a hollow tubular tip that fits into the outlet end of the first connector element, through the valve orifice, and between the valve elements, so as to flex apart the valve elements, thereby opening the valve. Upon removal of the tip from the valve orifice, the valve elements resiliently return to their closed position to close the valve, blocking fluid flow through the valve orifice.

### CROSS-REFERENCE TO RELATED APPLICATION

Not Applicable

### FEDERALLY SPONSORED RESEARCH OR DEVELOPMENT

Not Applicable

### BACKGROUND OF THE INVENTION

The present invention relates generally to the field of connectors for connecting segments of IV lines in an intravenous (IV) administration set. More specifically, it relates to a mechanism for removably coupling a downstream conduit to an upstream IV segment that allows fluid communication between the upstream IV line segment and the downstream conduit while the upstream line segment and the downstream conduit are coupled together, and that automatically closes the upstream line segment when the downstream conduit is disconnected from it.

In the use of IV administration sets, it is often necessary to connect and disconnect two or more lengths or segments of IV line. If this is done while the IV set is in use, it is necessary to shut off the flow of fluid. Accordingly, a clamp is typically applied to an appropriate place in the line segment that remains connected to the IV solution container (the upstream line segment) to prevent outflow from its downstream end during the process of connecting and disconnecting an adjoining IV line segment to the downstream end. Clamping the IV line can impair line integrity or affect the flow rate upon removal of the clamp.

Accordingly, a mechanism has been sought to allow a downstream IV line segment to be connected to, and disconnected from, the downstream end of an upstream IV line segment without the need to apply a clamp to the upstream line segment.

### SUMMARY OF THE INVENTION

Broadly, the present invention is a close-on-disconnect IV line connector pair, comprising a first connector element that is attachable to one end of a first IV line segment and that includes normally-closed valve; and a second connector element that is attachable to one end of a second line segment; wherein the coupling of the first and second connector elements to connect the first and second line segments automatically opens the valve; and wherein the disconnecting of the first and second connector elements allows the valve to return to its normally-closed position.

More specifically, the first connector element comprises a first connector element body having an inlet end and an outlet end. The interior of the first connector element body defines an internal valve orifice communicating between the inlet end and the outlet end. The inlet end of the body is configured for attachment to an upstream conduit, such as an IV line, while the outlet end is configured for coupling with the second connector element. Disposed within the first connector element is a duck-billed check valve comprising a pair of flexible, lip-like valve elements, each of which extends upstream (i.e., toward the inlet end) and radially inward from an anchoring bead lodged within an internal circumferential groove within the body. The valve elements have respective upstream ends that normally close against each other, so that the valve has a normally closed position that prevents fluid flow from the inlet end through the valve orifice. The valve elements are made of an elastomeric material that permits them to be resiliently flexed away from each other to permit fluid flow through the valve orifice and the outlet end of the first connector element.

The second connector element comprises a second connector element body having an inlet end and an outlet end. The outlet end of the body is configured for attachment to a downstream conduit, such as an IV line, while the inlet end is configured for coupling with the first connector element. Specifically, the inlet end is formed with a hollow tubular tip that fits into the outlet end of the first connector element, through the valve orifice, and between the valve elements, so as to flex apart the valve elements, thereby opening the valve. The tubular tip thereby forms a fluid conduit from the inlet end of the first connector element, through the valve orifice, and through the outlet end of the first connector element. Fluid can thus flow from the inlet end of the first connector element, then through the valve, the outlet end of the first connector element, and through the second connector element. Upon removal of the tip from the orifice of the first connector element, the valve elements resiliently return to their closed position to close the valve, blocking fluid flow through the valve orifice.

In the preferred embodiment, the invention is implemented as a modified pair of Luer connectors, the first connector element being implemented in the female connector and the second connector element being implemented in the male connector.

### BRIEF DESCRIPTION OF THE DRAWINGS

FIG. 1 is perspective view of an IV line connector pair, in accordance with a preferred embodiment of the present invention, showing the connector elements in the pair in their disconnected state;

FIG. 2 is a perspective view, similar to that of FIG. 1, showing the connector elements in their connected state;

FIG. 3 is a cross-sectional view of the upstream connector element, taken along line 3-3 of FIG. 1;

FIG. 4 is a cross-sectional view taken along line 4-4 of FIG. 3; and

FIG. 5 is a cross-sectional view of the connected connector element pair of FIG. 2, taken along line 5-5 of FIG. 2.

### DETAILED DESCRIPTION OF THE INVENTION

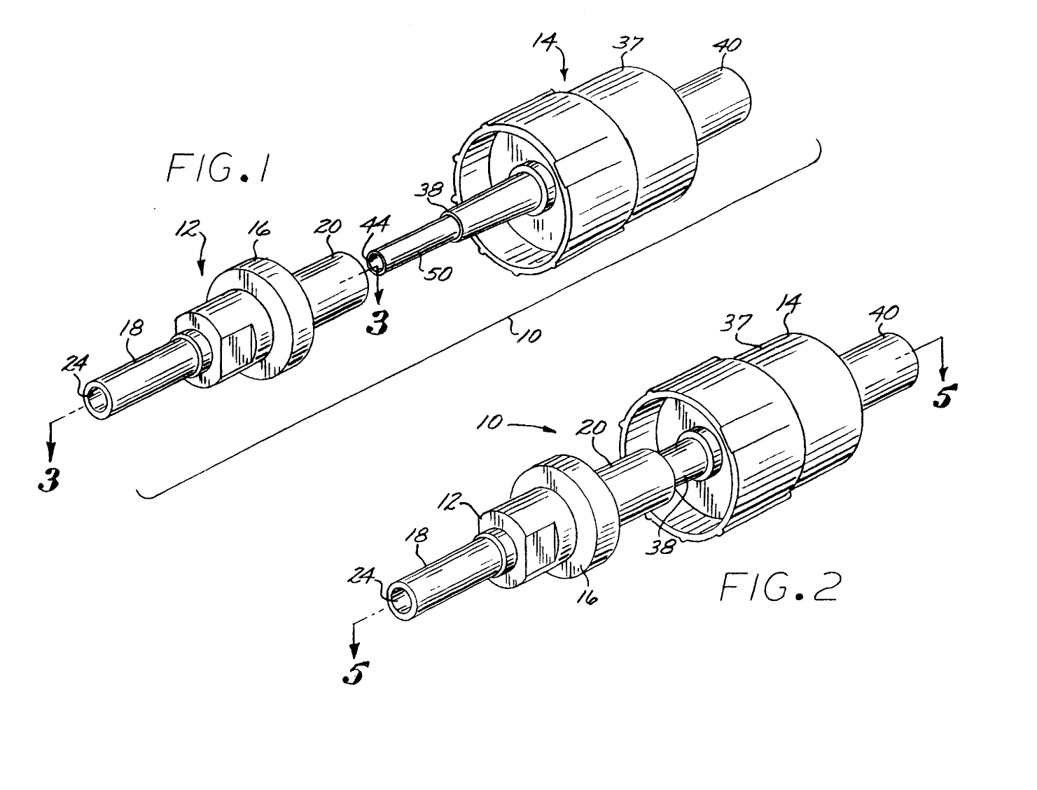

Referring to the drawings, a close-on-disconnect IV line connector pair 10, in accordance with a preferred embodiment of the invention, is shown. The connector pair 10 comprises a first or upstream connector element 12, and a second or downstream connector element 14. The upstream and downstream connector elements are shown in FIG. 1 in a disconnected or separated condition, and in FIG. 2 in a connected condition.

The first or upstream connector element 12 comprises a first connector element body 16 having an inlet end 18 and an outlet end 20. A first axial fluid flow passage 22 is defined between an inlet 24 in the inlet end 18 and a valve 26 (to be described below) in the flow passage between the inlet end 18 and the outlet end 20. The inlet end 18 of the body 16 is configured for attachment to an upstream conduit 17, such as an IV line, while the outlet end 20 is configured for coupling with the downstream connector element 14.

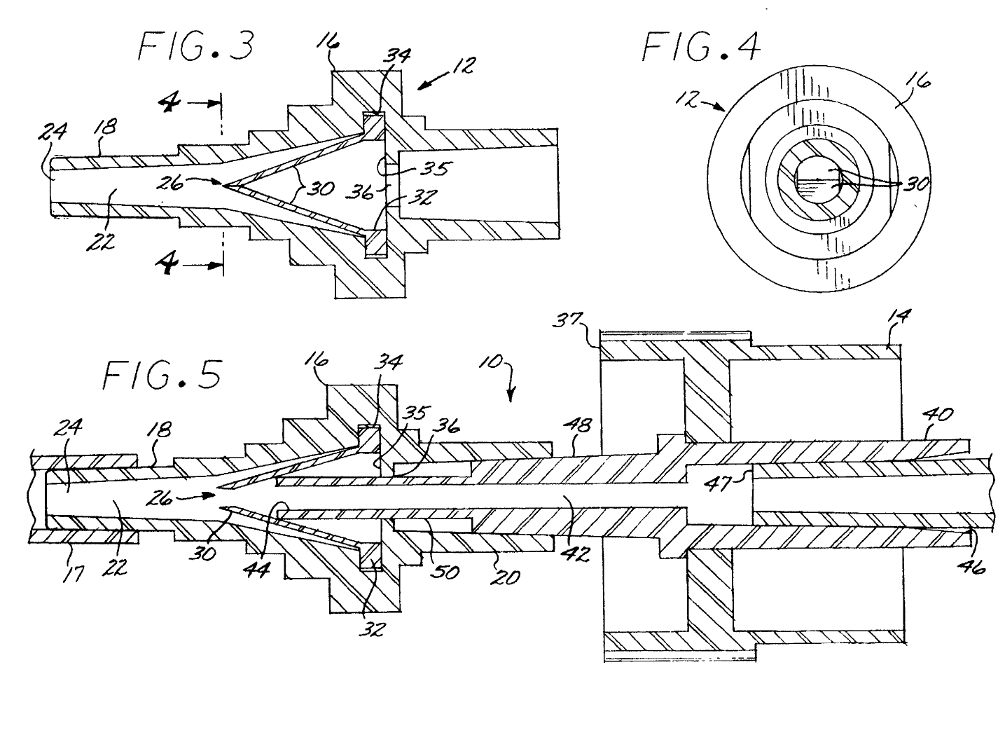

As best shown in FIGS. 3 and 4, the valve 26 is a duck-billed check valve comprising a pair of flexible, lip-like valve elements 30 that converge toward each other as they extend upstream (i.e., toward the inlet 24) and radially inward from an anchoring bead 32 captured within an internal circumferential groove 34 surrounding an annular shoulder 35 within the body 16. The shoulder 35, in turn, surrounds an orifice 36 that communicates with the outlet end 20. The valve elements 30 have respective upstream ends that normally close against each other, so that the valve 26 has a normally closed position that seals the downstream end of the first passage 22, blocking fluid flow through the orifice 36. The valve elements 30 are made of an elastomeric material that permits them to be resiliently flexed away from each other to permit fluid flow through the valve 26, as will be described below.

The second or downstream connector element 14 comprises a second connector element body 37 having an elongate, tubular inlet end 38 and an outlet end 40, and defining a second axial fluid flow passage 42 communicating between an inlet 44 in the inlet end 38 and an outlet 46 in the outlet end 40. The outlet end 40 of the body 37 is configured for attachment to a downstream conduit 47, such as an IV line, while the inlet end 38 is configured for coupling with the first or upstream connector element 12. Specifically, as best shown in FIG. 5, the inlet end 38 is configured to fit into the outlet end 20 and the valve orifice 36 of the first or upstream connector element 12, so as to flex apart the valve elements 30, thereby opening the valve 26. In a specific preferred embodiment, as shown in FIGS. 1 and 5, the inlet end 38 is formed as a tubular extension that includes a main portion 48 having an outside diameter sized to provide a fluid-tight frictional fit within the outlet end 20 of the upstream connector element 12. Extending from the main portion 48 is a reduced-diameter hollow tip 50 that is sized to pass through the orifice 36 of the valve 26 in the upstream connector element 12 to push apart the valve elements 30. Upon removal of the inlet end 38 of the downstream connector element 14 from the outlet end 20 of the upstream connector element 12, the valve elements 30 resiliently return to their closed position to close the valve 26, as shown in FIG. 3.

In operation, an upstream conduit 17, such as a first IV line connected to an IV solution container (not shown), is attached to the inlet end 18 of the first or upstream connector element 12. A downstream conduit 47, such as a second IV line connected to an IV needle or the like (not shown), is attached to the downstream end 40 of the second or downstream connector element 14. With the connector elements 12, 14 in their disconnected or separated condition (FIG. 1), the normally closed valve 26 in the upstream connector element 12 is in its closed state, blocking the orifice 36, and thereby preventing fluid flow through the upstream connector element 12.

When the downstream connector element 14 is connected to the upstream connector element 12, as shown in FIG. 5, the tip 50 of the inlet end 38 of the downstream connector element 14 enters the outlet end 20 of the upstream connector element 12, passes through the orifice 36 of the valve 26, and flexes the valve elements 30 apart as it enters the inlet end 18 of the upstream connector element 12. The hollow tip 50 and the main portion 48 of the inlet end 38 of the downstream connector element 14 thus provide a conduit for fluid to pass from the inlet end 18 of the upstream connector element 12, through the orifice 36, the outlet end 20 of the upstream connector element 12, and then through the body 37 and the outlet end 40 of the downstream connector element 14. Thus, the connection of the downstream connector element 14 to the upstream connector element 12 simultaneously opens the valve 26 to permit fluid flow from the upstream conduit 17 to the downstream conduit 47 through the connector pair 10.

When the connector elements 12, 14 are disconnected, the removal of the tip 50 from the orifice 36 allows the flexible valve elements 30 to return to their closed position, again preventing fluid from flowing from the inlet end 18 of the upstream connector element 12 through the orifice 36. Thus, disconnecting the connector elements 12, 14, simultaneously closes the valve 26 to block fluid flow from the upstream conduit 17 without the need to clamp it.

In the preferred embodiment, as can be seen from the drawings, the first or upstream connector element 12 is configured as a modified female Luer connector, while the second or downstream connector element 14 is configured as modified male Luer connector. This Luer-type configuration is not mandatory, however, and any suitable external configuration may be employed.

It can thus be seen that use of the connector pair 10 allows a quick, effective, and convenient way to eliminate the use of clamps when it is desired to disconnect a downstream IV line segment from an upstream line segment.

While a preferred embodiment of the invention has been described herein, it may be appreciated that modifications and variations may suggest themselves to those skilled in the pertinent arts. Such variations and modifications should be considered within the spirit and scope of the present invention, as defined in the claims that follow.

What is claimed is:

1. Apparatus for connecting a downstream conduit to an upstream conduit, comprising:
an upstream connector element having an inlet end configured for connection to the upstream conduit and an outlet end, and containing a normally-closed valve between the inlet end and the outlet end; and
a downstream connector element having an outlet end configured for connection to the downstream conduit and an inlet end configured for insertion into the outlet end of the upstream connector element, and for opening the valve when it is inserted into the outlet end of the upstream connector element.

2. The apparatus of claim 1, wherein the upstream connector element includes a valve orifice between the inlet end and the outlet end, and wherein the valve comprises a pair of flexible, lip-like valve elements that normally converge toward and close against each other as they extend upstream from the valve orifice.

3. The apparatus of claim 2, wherein the inlet end of the downstream connector element is configured to pass through the valve orifice and to flex apart the valve elements.

4. The apparatus of claim 3, wherein the inlet end of the downstream connector element is configured to provide a fluid-tight fit within the outlet end of the upstream connector element.

5. Apparatus for connecting a downstream conduit to an upstream conduit, comprising:
an upstream connector element having an inlet end configured for connection to the upstream conduit and an outlet end, with a fluid flow path defined between the inlet end and the and outlet end;
a normally-closed valve in the upstream connector in the fluid flow path between the inlet end and the outlet end, the valve comprising a pair of flexible valve elements that resiliently close against each other; and
a downstream connector element having an outlet end configured for connection to the downstream conduit and an elongate, tubular inlet end configured for insertion into the outlet end of the upstream connector element with a fluid-tight fit, whereby the tubular inlet end of the downstream connector element flexes apart the valve elements to open the valve when it is inserted into outlet end of the upstream connector element.

6. The apparatus of claim 5, wherein the fluid flow path includes a valve orifice between the inlet and outlet ends of the upstream connector element, and wherein the valve elements normally converge toward and close against each other as they extend upstream from the valve orifice.

7. The apparatus of claim 6, wherein the tubular inlet end of the downstream connector element is configured to pass through the valve orifice.

8. A method of connecting a downstream conduit to an upstream conduit and disconnecting the downstream conduit from the upstream conduit, comprising the steps of:
providing an upstream connector element having an inlet end and an outlet end, and containing a normally-closed valve between the inlet end and the outlet end;
providing a downstream connector element having an outlet end and an inlet end;
attaching the upstream conduit to the inlet end of the upstream connector element;
attaching the downstream conduit to the outlet end of the downstream connector element;
simultaneously connecting the downstream connector element to the upstream connector element and opening the valve by inserting the inlet end of the downstream connector element into the outlet end of the upstream connector element so as to open the valve; and
simultaneously disconnecting the downstream connector element from the upstream connector element and closing the valve by removing the inlet end of the downstream connector element from the outlet end of the upstream connector element so as to allow the valve to return to its normally closed position.

9. The method of claim 8, wherein the valve comprises a pair of flexible valve elements that are normally closed against each other, and wherein during the insertion of the inlet end of the downstream connector element into outlet end of the upstream connector element, the inlet end of the downstream connector element flexes apart the valve elements to open the valve.
